(19) United States
(12) Patent Application Publication
(10) Pub. No.: US 2002/0111190 A1
(43) Pub. Date: Aug. 15, 2002

(54) Base station/data storage

(76) Inventors: Keith Alexander Harrison, Woodcroft Chepstow (GB); Matthew John Lawman, Bath (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/053,522

(22) Filed: Jan. 23, 2002

(30) Foreign Application Priority Data
Jan. 24, 2001 (GB) 0101785.4

(51) Int. Cl. H04M 1/00

(52) U.S. Cl. 455/557; 455/573

(57) ABSTRACT

A base station (data safe) is provided for storing data from a portable data storage device, typically a personal digital assistant (PDA). The base station includes a data storage device and a power supply. The PDA downloads data into the storage device and recharges an internal power source from the power supply The data is stored in the base station, as a back-up of the data on the PDA.

### BACKGROUND OF THE INVENTION

1. Field of the Invention

This invention relates primarily to a base station and to data storage More particularly, but not exclusively, it relates to a base station for use in producing a back-up from a personal digital assistant (PDA).

2. Description of Related Art

PDA's are used primarily for the writing of notes, diarying and similar functions with limited use for the receiving and sending of e-mails.

Back-ups of data contained on a PDA are desirable as damage to the PDA, for example caused by dropping the PDA on a hard surface or accidental immersion in water, can result in the contents of it's memory being lost.

ln order to back-up a PDA, it is necessary to connect the PDA to a PC and use the hard disk of the PC as the storage medium for the back-up, as shown in FIG. 1. This is clearly a problem for owners of PDA's who do not own a PC or may be travelling and not able to readily access their PC. Such people simply do not keep back-ups of the data stored in their PDA, or at least not until they get home and have access to a PC (if they have one).

### SUMMARY OF THE INVENTION

It is an aim of the present invention to provide a base station for, and a method of, backing up the memory of a portable device such as a PDA, which, at least partly, ameliorates at least one of the above-mentioned disadvantages. Having this as an aim is at least in part an element of the invention. Previously people have simply put up with the problems.

According to the present invention there is provided a base station, (data safe), comprising a power source, a data storage device and an interface, the interface being adapted to transfer, in use, data from a portable data-holding device, to the data storage device, the data storage device being adapted to, in use, store said data, the power source recharging a second power source of the pox-table device, in use.

The portable device may be a PDA. The base station may, in use, support the portable device. The portable device may, in use, be physically held by the base station. The base station may, in use, receive the portable device.

The interface. may have a comb type connection between the portable device and the. base station. The interface may have a pin/socket type connector. The connector may co-operate with a complimentarily shaped connector on the portable device, in use. The connectors may establish a data link between the base station and the portable, device. Alternatively, the connectors may provide power to the portable device for recharging and the data link may be provided in another way (e.g. wireless link). There, may be an infra-red or radio frequency data link between the base station and the portable device.

The power source may maintain data within the storage device. There may be provided an electrical connection between the base station and the portable device. The power source may include a transformer for transforming mains electricity supply to lower voltage supply. The power source may be a battery, cell or it may be an a.c. transformer. The battery may be a lithium ion battery.

The data storage device may have a data capacity that is a multiple of the data capacity of the portable device. The data storage device may have a data capacity of between any pair of the following <8 Mb, 8 Mb, 16 Mb, 32 Mb, 64 Mb, 128 Mb, 256 Mb, 512 Mb>512 Mb. There may be provided a gauge showing the remaining data capacity of the data storage device. The gauge may be in the form of an icon on a user interface, e.g. screen, of the portable device or it may be on the base station The base station may only back up active data, e.g. not applications programs.

The base station may be portable. The base station may weigh less than about 1 kg, 500 g or 250 g. The base station may be adapted to either upload or download data to/from the portable device or may be adapted to do both. The storage device may be able to store multiple downloads from the portable device.

There may be a control or controls, possibly on a control panel on a screen of the portable device which enables download/upload of data. There may be one or more switches on the body of the base station which enable download/upload of data. A PIN number or other identification code may have to be entered before data can be downloaded/uploaded to/from the base station. A user of the base station may allocate the PIN/identification code upon down loading data from the portable device. The PIN/identification code may be required to be entered prior to uploading data to the portable device. The PIN/identification code may allow access to data associated with a specific user. The PIN may be entered over a user interface, e.g. screen, of the portable device A prompt may be provided prior to executing a back-up The prompt may need to be responded to to avoid executing a back-up. Alternatively, the data may be backed-up automatically, in use. Thus, it is just as easy for a user to accept a data back-up as it is to refuse it. This can encourage good data management. A data back-up may take less than a second or of the order of seconds, as opposed to minutes.

There may be provided a flash card slot to extend the storage capacity of the station. Although a PDA as the primary portable device envisaged, the base station may be associated with other portable devices such as a digital camera or a mobile phone.

The base station is not a PC. The base station may have only limited functionality, for example it may be adapted to only store back-up data from the portable device and reload it back into the portable device, if required. Additionally it will recharge an internal power source of the portable device. The base station may not have a manually generated source of data associated with it, e.g. it may not have a keyboard. The base station may not have a data processing facility, it may only store the data. The base station may not be a general purpose device The base station may be simple and cheap to manufacture when compared to a PC. The base station may resemble a brick. The base station may have no moving parts. There may be only moving switches and buttons associated with the base station.

According to a further aspect of the present invention there is provided a method of data back-up comprising the steps of:

i) providing a data safe according to the first aspect of the present invention;

ii) coupling a portable data containing device to the data safe;

iii) downloading data from the device to the data safe, and

iv) recharging a power source of the device by a power source associated with the data safe.

The method may further comprise providing the data safe in a portable, ideally able to be held in the hand, size. The method may further include prompting a user of the device to indicate whether they wish to back-up the data.

According to a still further aspect of the present invention there is provided a method of data preservation comprising providing a small data safe (e.g. small enough to be held in the palm of one hand) and downloading data from a portable data holding device to the data safe as a default condition of the coupling of the portable device and the data safe, or at least as an option that involves no more user input than does not downloading and recharging a battery part of the device when the device and data safe are coupled.

According to a yet still further aspect of the present invention there is provided a combination of a base station according to the first aspect of the present invention and a portable data holding device adapted such that, in use, the portable device is received by the base station, data being transferable between the device and the base station.

The base station may occupy a, slightly larger area than one face of the device.

One of either of the device or base station may have a male connector and the other having a complementary female connector to allow the transfer of data therebetween. Alternatively there may be an infra-red or radio link between the device and the base station. The device may be a PDA.

The base station may be able to recognise a number of portable devices. The number of devices which the base station can recognise may be limited, for example a device may be ‘introduced’ to the base station and a coded identifier associated with the device may be stored in the base station and only those devices which have an identifier which is known to the base station may back-up to the base station. The device identifier may allow selective writing of data to specific memory blocks.

Each portable device user may have their own identifier The identifier may take the form of a PIN. Each portable device users back-up's may be taken to a specific memory block within the base station. This allows, for example, families to allocate varying portions of the base station storage device to individual family members and also increases the privacy of data stored in the base station. The device identifier and the user identifier may be required to allow data to be backed-up to the base station or to be uploaded to the device.

### DESCRIPTION OF THE DRAWINGS

The invention will now be described, by way of example, with reference to the accompanying drawings in which:

FIG. 1 is a schematic representation of a prior art arrangement; and

FIGS. 2a to 2d are representations of a base station in accordance with the present inventions in use with a PDA.

### DESCRIPTION OF THE PREFERRED EMBODIMENT

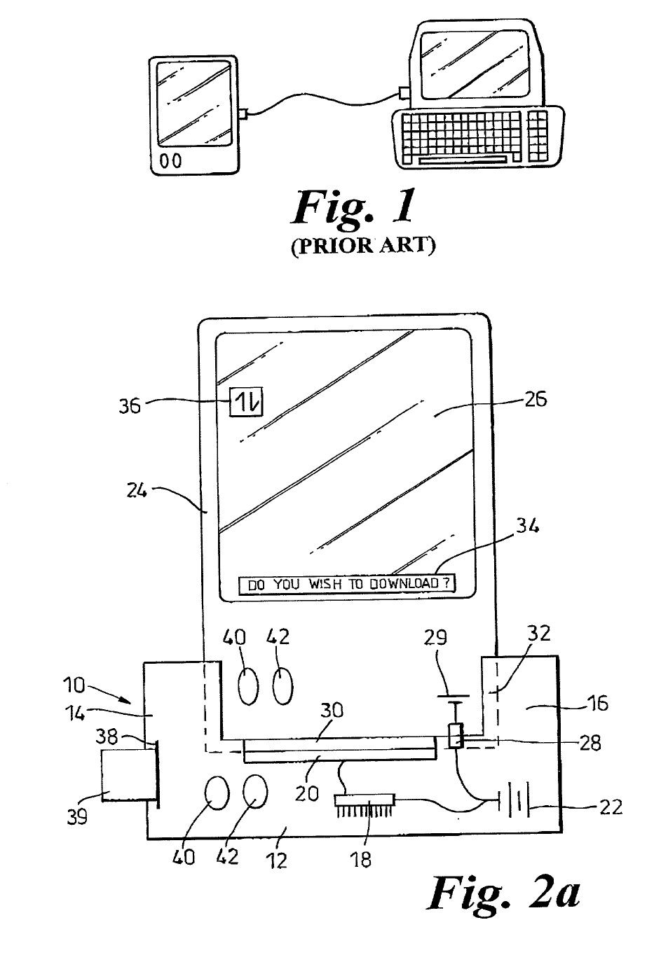

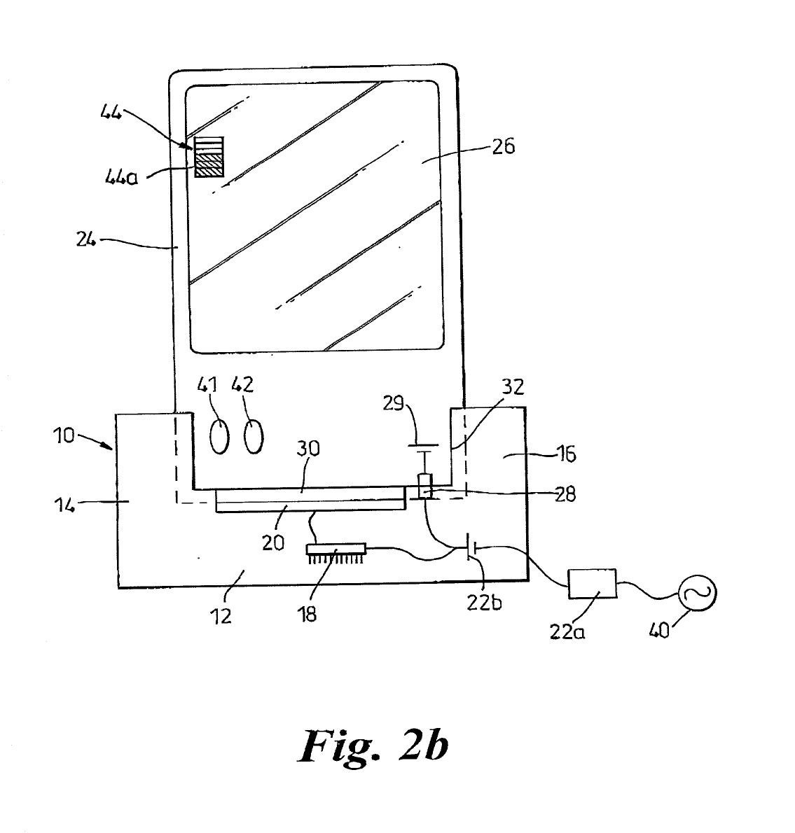

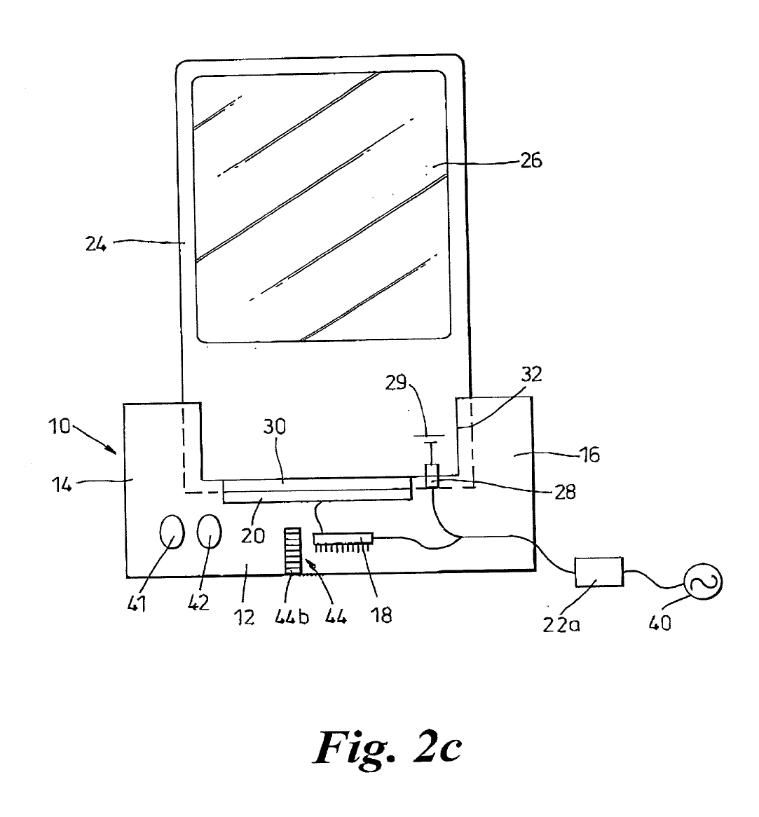

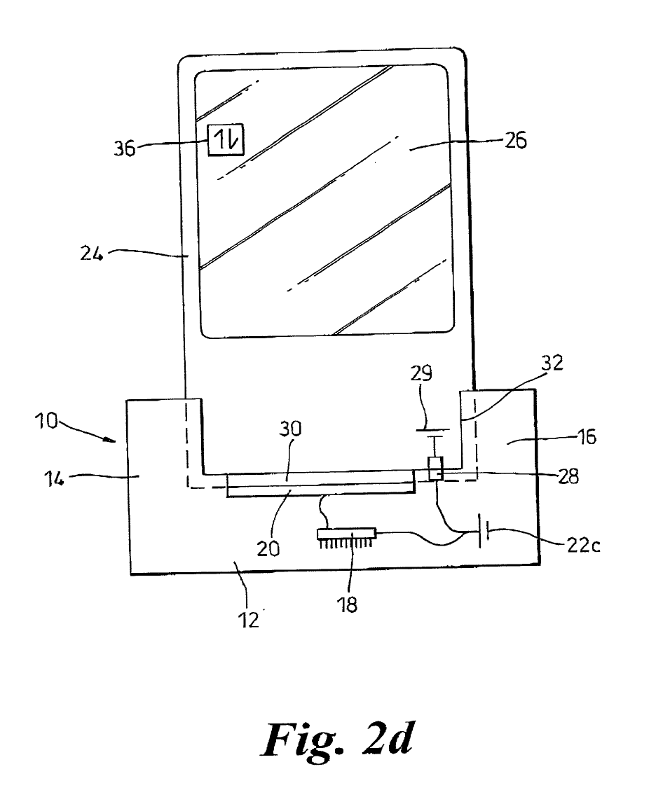

Current arrangements for backing up a PDA require the connection of the PDA to a PC, as shown in FIG. 1. Data can be transferred between the PDA and the PC over a communications link such as a lead or an infra-red data link. This does require a PDA owner to own, or at least have access to the PC in order to back-up their data. Also PC's are not readily transportable and travellers may wish to back-up their PDA's whilst away from their office or home and their PC's may not be readily accessible over a network.

A base station 10 comprises a body 12 and two support arms 14, 16. The body 12 houses a data storage device 18, an interface 20 and a power source 22.

A personal digital assistant (PDA) 24 has a screen 26, a power socket 28, an internal battery 29 and an interface 30.

The internal surfaces of the body 12, and the arms 14, 16 have a continuous U-shaped channel section 32 thereabout which runs between the free ends of the arms 14, 16 and defines a socket adapted to receive the PDA. The channel section 32 is slightly wider than the width of the PDA 24. The channel section 32 is adapted to receive the PDA 24, in use, such that the PDA 24 fits snugly in the channel 32 in effect cradling the PDA 24.

The storage device 18 will typically be RAM which requires power to maintain the data integrity. The power source 22 supplies the power requirements of the storage device 18.

The storage device 18 will typically have sufficient data storage capacity to store multiple downloads of data from the PDA 24. Current PDA storage capacity is typically approximately 8 Mb. It may be possible to compress the data from the PDA prior to its storage thereby increasing the number of downloads that can be stored in a base station.

The interface 20 communicates with the storage device 18 and data can be passed both ways between them, i.e. data download from the PDA 24 and upon a suitable command data upload from the base station 10 to the PDA 24.

The interface 20 is positioned in the channel 32 of the body 12 and connects with the interface 30 of the PDA 24, in use. The interfaces 20, 30 are typically in the form of complementary comb connectors or pin/hole connectors and are repeatedly engageable/disengageable.

When the PDA 24 is supported by the base station 10 there may be a prompt 34 that appears on the screen 26 requesting confirmation that a download of data from the PDA 24 to the base station 10 is not required. Unless positive confirmation that a download is not required is forthcoming a download of data will proceed into the base station 10 from the PDA 24 via the interfaces 20, 30 after a predetermined wait for the download to begin. A PIN may be required in some embodiments before the transfer of data either to, or from, the base station 10 can commence. The PIN can either be allocated by the PDA 24 or the base station 10. Alternatively, the PIN may be self-allocated over a user interface of the PDA 24 such as, for example, a screen by a user. The PIN may allow access to only part of the data storage device 18, for example to data associated with a specific user.

It will be appreciated that the term download is used to mean copying the data from the PDA into the base station and not the transfer of data to the base station and its subsequent erasure from the PDA.

Alternatively, there may be a control panel 36 which is on the screen 26 and controls data upload/download to the base station 10.

The interface 20 is arranged so as to be able to receive data from the PDA 24 via the interface 30, in use. The data is passed to the storage device 18 where it is stored.

The base station 10 may, in some embodiments, have a slot 38 therein which is adapted to receive a memory flash card 39 in order to add storage capacity to the base station 10.

The power source 22 in any of the embodiments can be a transformer 22a which may step down an a.c. supply voltage 40 The transformer 22a may also rectify the a.c. to d.c. Alternatively, the power source may be a rechargeable battery 22b or a removable non-chargeable battery 22c. The transformer 22a may recharge the battery 22b, in use.

The power source 22 can supply power to recharge an internal battery of the PDA 24. The power source 22 may be at battery, particularly a Li⁺ battery, or an a.c. transformer.

In some embodiments either, or both, of the base station 10 or/and PDA 24 may be provided with an upload button 41 and a download button 42 to control the transfer of data between the base station 10 and the PDA 24.

There may in some embodiments be provided a gauge 44 to indicate how much of the data storage capacity of the data storage device 18 is used/remains unused. The gauge 44 may be in the form of an icon 44a on a user interface, e.g. a screen, of the PDA 24. Alternatively, the gauge 44 may be in the form of a series of LED's 44b or other visible means on the base station 10.

The base station 10 may obviate the need for tethering the PDA 24 to a PC in order to execute uploads/downloads of data.

It will be appreciated that any suitable combination of upload/download controls and power supply may be used in various embodiments of the present invention.

1. A base station for safekeeping of data, the base station composing a power source, a data storage device and an interface, wherein the interface is operable to transfer data from a portable data-holding device to the data storage device for storing the data in said device, and the power sore is operable to recharge a power source of he portable data-holding device.

2. A base station as claimed in claim 1, adapted to receive the portable data-holding device.

3. A base station as claimed in claim 1, wherein the data storage device has a data storage capacity of n×a data storage capacity of the portable data-holding device, n being an integer.

4. A base station as claimed in claim 1, wherein the data storage device is operable to store multiple downloads from the portable data-holding device.

5. A base station as claimed in claim 1, the base station being portable.

6. A base station as claimed claim 1, operable to upload and download data from. the portable data-holding device.

7. A base station as claimed in claim 1, having no moving parts.

8. A method of data back-up comprising:
a) providing a data safe;
b) coupling a portable data-containing device to the data safe;
c) downloading data from the portable data-containing device to the data safe; and
d) recharging a power source of the portable data-containing device using a power source associated with the data safe.

9. A method as claimed in claim 8, comprising prompting a user of the device to indicate whether to back-up the data.

10. A method of data preservation comprising:
a) providing a small data safe;
b) downloading data from a portable data-holding device to the data safe as a default condition when the portable device and the data safe are coupled, or at least as a condition involving no more user input tan does not downloading; and
c) recharging a battery of the portable data-holding device when said device and the data safe are coupled.

11. A combination comprising a base station as claimed in claim 1 and a portable data-holding device receivable by the base station, data being transferable between the portable data-holding device and the base station.

12. A combination as claimed in claim 11, wherein the base station occupies a slightly larger area than one face of the portable data-holding device.

13. A combination as claimed in claim 11, wherein the base station is adapted to recognise a coded identifier associated with a specific said portable data-holding device.

14. A combination as claimed in claim 13, wherein data stored on the specific said portable data-holding device is backed up to a corresponding specific portion of the data storage device, in use.

15. A combination as claimed in claim 11, wherein a user of a specific said portable data-holding device is assigned a personal identification number (PIN).

16. A combination as claimed in claim 15, wherein the PIN determines which specific portion of the data storage device receives the user's back up, in use.

17. A combination as claimed in claim 11, wherein a coded identifier and a PIN are required to transfer data between the portable data-holding device and the base station.

18. Means for backing up data, comprising:
a) means for safekeeping data;
b) means for coupling a portable data-containing device to the means for safekeeping data;
c) means for downloading data from the portable data-containing device to the means for safekeeping data; and
d) means for recharging a power source of the portable data-containing device using a power source associated with the mean s for safekeeping data.

19. Means for preserving data, comprising:
a) data-safe means for safekeeping data;
b) means for downloading data from a portable means for holding data to the data safe means as a default condition when the portable means and the data safe means are coupled, or at least as a condition involving no more user input than does not downloading; and
c) means for recharging a battery of the portable means for holding data when said portable means and the data safe are coupled.
